(19) United States
(12) Patent Application Publication
(10) Pub. No.: US 2012/0016802 A1
(43) Pub. Date: Jan. 19, 2012

(54) AUTOMATIC EVENT MANAGEMENT FOR REGULATION COMPLIANCE

(75) Inventors: YING ZENG, Fremont, CA (US); ATUL SUDHALKAR, Sunnyvale, CA (US); PETR STASTNY, Brno (CZ); PRATHAP SAKALA, Newark, CA (US)

(73) Assignee: SAP AG, Walldorf (DE)

(21) Appl. No.: 12/838,135

(22) Filed: Jul. 16, 2010

(51) Int. Cl. G06Q 99/00

(52) U.S. Cl. 705/317

(57) ABSTRACT

In one embodiment, a method includes determining a plurality of event types where each event type associated with event metadata. An event is received and an event type in the plurality of event types for the received event is determined. The method determines event metadata for the determined event type and event data from the event based on the event metadata. A rule associated with the event type is determined where the rule includes a criterion based on a regulatory compliance issue. A computing device evaluates the event data with the criterion to determine if the event is non-compliant or compliant with the regulatory compliance issue.

### BACKGROUND

Particular embodiments generally relate to computer-based business application processing.

Companies face many different regulations from government agencies, other regulatory bodies, and sometimes internal policies within the companies. Companies need to have in place controls and monitoring to ensure compliance. As regulations and market expectations become more stringent and demanding, the number and cost of such controls increases.

Companies typically view compliance monitoring as an exception-driven process. Normal operations continue without interruption; occasionally, compliance issues occur, which raise the risks to the business of violating laws, regulations or even just good business practices. The company's business processes continue, but a user gets alerted, investigates, and corrects any errors or problems.

Accordingly, due in part to the above view, compliance tools conventionally use a scheduled monitoring approach. For example, queries and other methods of monitoring business transactions (both automated and manual) are performed on a set schedule. The business transactions may be queried for at a date/time interval. The results of the queries are then monitored for compliance. The monitoring process imposes a fixed tax or cost on the business operations. That is, whether or not any activity has occurred, the monitoring tax has to be paid. However, reducing the frequency of monitoring increases risks of non-compliance, i.e., if monitoring is performed less frequently, more risks of non-compliance can happen between two consecutive checks.

When a non-compliant transaction is detected after a certain time, damages may have already occurred and can cause large losses for companies. This is because companies expect the business operations to continue and only monitor for non-compliant transactions over certain intervals. When a non-compliant transaction occurs, the business operations continue while the issue is investigated and can still cause losses.

### SUMMARY

In one embodiment, a method includes determining a plurality of event types where each event type associated with event metadata. An event is received and an event type in the plurality of event types for the received event is determined. The method determines event metadata for the determined event type and event data from the event based on the event metadata. A rule associated with the event type is determined where the rule includes a criterion based on a regulatory compliance issue. A computing device evaluates the event data with the criterion to determine if the event is non-compliant or compliant with the regulatory compliance issue.

In one embodiment, determining the rule includes determining a control associated with the event type, the control based on a risk of non-compliance for the regulatory compliance issue and determining the rule from the control.

In one embodiment, the event is received from an outside system through an event interface.

In another embodiment, a computer-readable storage medium containing instructions for controlling a computer system to perform a method is provided. The method includes determining a plurality of event types where each event type associated with event metadata. An event is received and an event type in the plurality of event types for the received event is determined. The method determines event metadata for the determined event type and event data from the event based on the event metadata. A rule associated with the event type is determined where the rule includes a criterion based on a regulatory compliance issue. The event data is evaluated with the criterion to determine if the event is non-compliant or compliant with the regulatory compliance issue.

In one embodiment, the method further includes determining a control associated with the event type, the control based on a risk of non-compliance for the regulatory compliance issue and determining the rule from the control.

In one embodiment, the method further includes triggering a workflow to perform predetermined actions for remediating the event if the event is determined to be non-compliant.

In another embodiment, an apparatus includes one or more computer processors and a computer-readable storage medium containing instructions for controlling the one or more computer processors to perform a method. The method includes determining a plurality of event types where each event type associated with event metadata. An event is received and an event type in the plurality of event types for the received event is determined. The method determines event metadata for the determined event type and event data from the event based on the event metadata. A rule associated with the event type is determined where the rule includes a criterion based on a regulatory compliance issue. The event data is evaluated with the criterion to determine if the event is non-compliant or compliant with the regulatory compliance issue.

The following detailed description and accompanying drawings provide a better understanding of the nature and advantages of the present invention.

### BRIEF DESCRIPTION OF THE DRAWINGS

FIG. 1 depicts an example of a system for providing event-driven regulatory compliance monitoring according to one embodiment.

FIG. 2 depicts a more detailed example of the system according to one embodiment.

FIG. 3 depicts a simplified flowchart of a method for determining a rule for an event according to one embodiment.

FIG. 4 depicts a simplified flowchart of a method for evaluating an event according to one embodiment.

FIG. 5 depicts a simplified flowchart for providing remediation according to one embodiment.

FIG. 6 illustrates hardware of a special purpose computing machine configured with an event-based regulatory compliance system according to one embodiment.

### DETAILED DESCRIPTION

Described herein are techniques for event-driven business application processing. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

Particular embodiments provide an event-driven architecture for regulatory compliance monitoring. The architecture delivers an efficient cost-effective, real-time or near real-time compliance monitoring. The event-driven approach responds to events as they arise. Normal compliance issues can be detected and responsible users to remediate the issue can be informed. Also, a business workflow may be triggered and preventive and corrective measures can be taken. Thus, event-driven monitoring provides a combination of limited or predictable load on computing systems, fine-grain configurability as to what is to be monitored, and timely monitoring of business activities.

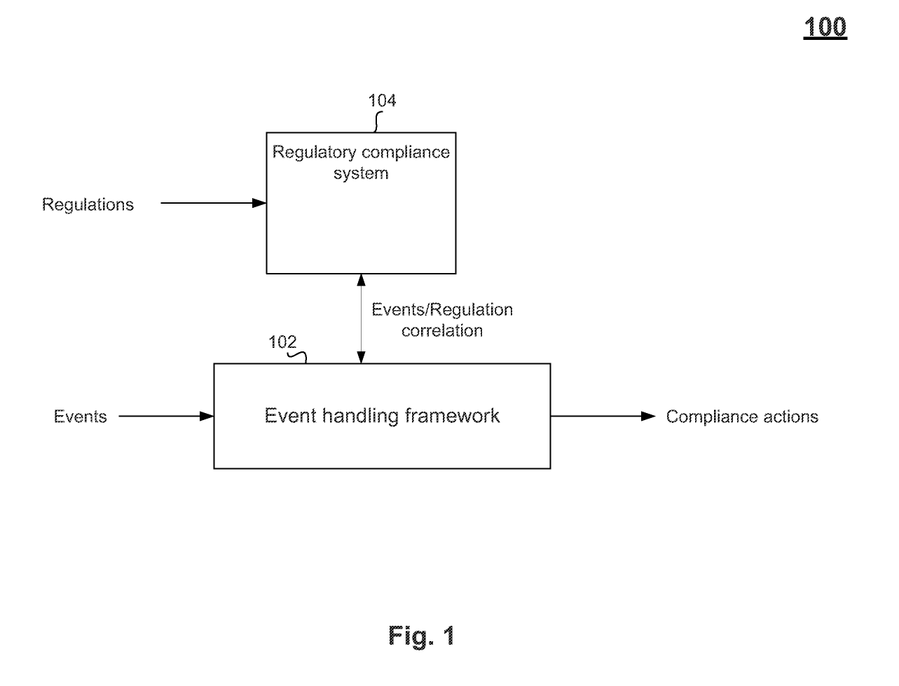

FIG. 1 depicts an example of a system 100 for providing event-driven regulatory compliance monitoring according to one embodiment. System 100 includes an event-handling framework 102 and a regulatory compliance system 104. System 100 may be part of a Governance, Risk Management, and Compliance (GRC) system.

Regulatory compliance system 104 allows the set up of data that governs the regulatory compliance. Regulatory compliance system 104 may receive regulations and related information needed for a compliance system. For example, the information that may be configured includes regulation/policy and their requirements, business processes/sub-processes, organization unit hierarchy of the company, risks related to non-compliance with specific regulations, controls to check/detect or mitigate the non-compliance risks, and rules to define automatic controls to detect non-compliance business cases. The information set up will be described in more detail below.

Event handling framework 102 is configured to process the events that occur. The event may be information that is generated by a system and sent to event handling framework 102 without a query from event handling framework 102. The event may be generated based on a transaction and includes information about the transaction. The events may occur anywhere and may be sent to event handling framework 102. For example, the event may occur using systems that process business transactions for the company. These systems may be located outside of event-handling framework 102. For example, payment transactions may be processed by a payment transaction system.

Events may be received in different formats because the events may be processed by other systems. Accordingly, event data in an event needs to be interpreted by event handling framework 102. As will be described in more detail below, event metadata for an event type is used to interpret event data in the event. Also, the event is correlated to a rule for a control associated with a regulation. The rule includes one or more criteria that are used to evaluate the event for non-compliance with the regulation. If the event is non-compliant, compliance actions may be performed. For example, a workflow may be triggered to handle the non-compliant event and automatically notify appropriate users or systems, or perform actions to remediate the issue. Also, the non-compliant event may be output on an interface for a user to view where the user can determine actions to take. This process will be described in more detail below.

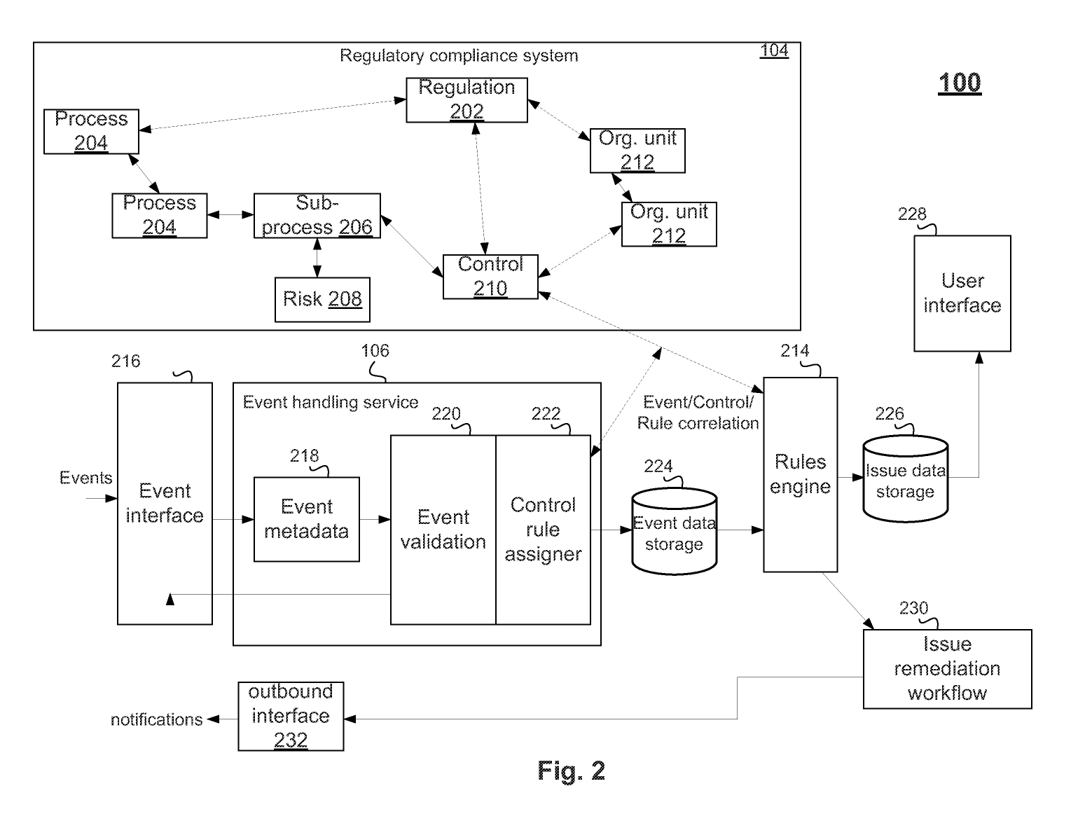

FIG. 2 depicts a more detailed example of system 100 according to one embodiment. The following describes the configuration of regulatory compliance system 104. Then, the handling of events is described using event handling framework 102. Regulatory compliance system 104 is configured such that events can be linked to regulations. As will be described below, event types are used to link events to controls and rules for regulations. Also, event metadata for the event types are used to interpret data in the event to allow for evaluation of the event with the rules.

Regulatory compliance system 104 may be used to set up the regulations and their requirements. For example, a database structure may be used to describe the regulation and the regulation's requirements. The database structure is shown conceptually in system 104. Links between different entities in the database structure are shown and will be described below. A person of skilled in the art will appreciate how to link different entities in the database structure as described below based on the teachings and disclosure herein.

A regulation may control or restrict behavior. Regulations include policies and rules. General information of the regulations and their requirements may be received from a user and also related documentation may be attached to the regulations. For example, at 202, regulations may be set up. The received regulation may be a set of requirements that need to be complied with for a company. The requirements may be attached to the regulation. In one example, high level English language descriptions of regulations, such as company policies and government regulations, may be grouped together and contain regulation requirements. These may be stored in a time-dependent database table. Additionally, which business entities may be affected by the regulation is determined and are linked to regulations through organizational units (org units) at 212, which will be described in more detail below.

The business processes impacted by all the regulations and their requirements are then set up. One example of a business process may be payment processing. At 204, business processes related to the company are maintained. These are the business activities that the company performs. Business processes may form a process hierarchy. For example, at 206, sub-processes may be created as children of processes.

At 208, risks of non-compliance for different regulations are identified. The risks may be defined as areas where non-compliance could result. The risks may identify business risks of non-compliance to specific regulations.

At 210, controls are created to manage risk. For example, controls check the compliance of a regulation for different business processes and sub-processes or mitigate the risks of non-compliance. Controls describe activities that may be performed to control the risk. For example, the controls may be surveys, self-assessments, or computer programs that search for the company's business database and business information systems to identify non-compliant events.

At 212, an organizational structure of the company is also set up. For example, different organizational units may be provided. Different regulations may have different impacts on different organization units and locations. Also, different organization units may also perform different business processes and sub-processes.

The linking of entities in system 104 will now be described. The organizational units are linked to different regulations at 202 because different regulations apply to different organizational units. Each organizational unit may model a set of processes, sub-processes, controls, and risks that are assigned to specific regulations based on the relevance to the regulations to each organizational unit.

The processes and sub-processes are used to build a link to daily business activities the organizational unit is performing. Processes and sub-processes may be linked to specific regulations that the business processes or sub-processes may affect with regard to compliance issues for the organizational unit. The relationships between the individual organizational units and business processes that are associated with each organizational unit may be stored in a time-dependent relationship table and the link is shown via dotted lines between processes at 204, regulations at 202, and org. units at 212.

Under the processes and the sub-processes, risks can be created to identify potential non-compliance risks, and controls can be defined to handle detection of processing of non-compliance events. The controls are then linked to the processes and sub-processes to cover the risks of non-compliance of a certain regulation. Controls may be related to the process or sub-process via a relationship table. The controls monitor the specific processes and sub-processes. The controls may cover different risks. For example, for each risk, a set of controls may be linked to the risk. For each process or sub-process, a different set of risks and controls may be used. Each org. unit and regulation may have their own set of controls, which is designated by the dotted lines between the controls at 210 with regulations at 202 or org. units at 212.

Rules are assigned to the controls to detect non-compliant events. The rules may be set up at a rules engine 214. How the rules may be processed may be defined by a user. For example, criteria for non-compliant events and filter criteria to select events as non-compliant may be configured. Tables may store the definitions for the criteria. Also, the rule definitions may be changed and are flexible.

The rules define criteria that are used to determine non-compliance for an event. As used, the term criteria may be a single criterion or multiple criteria. In one example, a rule may be “if the invoice item value is higher than $10,000 U.S. dollars and the customer is a one-time customer, then it is a non-compliance event.” The criteria in the rule are the amount of money (e.g., $10,000 U.S. dollars) and the customer type (e.g., one-time customer). Different rules may be provided for different controls. For example, for each control, a set of rules may be linked to the control. As will be discussed below, when events occur that are associated with controls, the events are evaluated based on the criteria of the rules associated with the controls.

To account for events being received from different systems with different data, event types may be configured with event metadata. The metadata is used to interpret the data in the events and will be described in more detail below. Also, the event type is linked to a control and a rule associated with the rule. For example, when the controls are configured, the controls are linked to specific event types in a database table. The control that an event type is linked to may be associated with different entities depending on the configuration of regulatory compliance system 104. For example, a control for a process or sub-process associated with an org. unit is linked to an event type.

The event type includes metadata describe data that is expected to be included in an event that is generated for the control. Metadata may be configured for each event type in system 100. Metadata may also be configured for different event originating systems, which may be identified by partner IDs. For each partner ID, multiple event types may be defined. Also, for each event type for different partner IDs may have different versions configured with specific metadata information.

Event-handling framework 102 will now be described in more detail. Event handling framework 102 is a central engine that performs compliance violation detection and monitoring. The events passed to event handling framework 102 may be triggered based on being flagged as possible compliance issues. For example, systems may flag transactions that violate certain limits or thresholds or may violate a proxy law or export control law.

An event interface 216 is provided to receive events. As business transactions occur on different systems, events containing information from these business transactions are received through interface 216. The systems that may trigger the events may be located anywhere, such as outside the company. For example, the systems include enterprise resource planning (ERP) programs, information technology (IT) systems, networking systems, and other systems. A vast range of types of information can be passed to event handling framework 102 in a generic format.

In one embodiment, interface 216 is a generic web service that can accept different types of events. Interface 216 may also be implemented as a remote function call or with other technologies. A remote function call may be an interface for a communication between interface 216 and another external system. The remote function call is the call of a function run on the external system and calls interface 216 to send the event to interface 216.

Event interface 216 passes the event to event handling service 217, which processes the event. The event may include different event data. For example, the event data may include an event type. The event type may a description that identifies the event.

Other information in the event may include an event identifier (ID), partner ID, version, status, date, time, and event detail data. The partner ID may be an identifier for an event originating system that sends events to event handling framework 102. The version may reflect possible changes of event data of one event type over time. Different metadata may be used for different versions. The status may be the current status for the event. The event detail data describes the event. For example, detail data may be arranged in attribute name and value pairs. The attribute name may describe a type of data, such as an item value. The value may include multiple or single values, such as an amount. Events of a different event type contain different attribute name/value pairs. For example, one event related to an invoice may include the attribute names of invoice number, fiscal year, business name, customer name, customer type (one-time customer or not), posting date, invoice item number, and invoice item values. The different attribute names may include attribute properties such as data type, data length, and other attribute properties. The properties define how the values should be formatted.

The event data may be generated by different systems. For event handling service 217 to process these different events, a method to understand what data is in the event may be used. Accordingly, event metadata 218 may be used to determine relevant information from the event that can be processed by rules engine 214. For example, metadata for different event types may be defined. Each event type may include specific metadata and also multiple versions of different metadata. The event metadata describes information that may be found in an event of that event type.

When an event is received, the event is linked to an event type. For example, a field in the event may define the event type. Also, the event may be parsed to determine an event type that is associated with the event. For example, the system the event is received from may be used to determine an event type of the event. Once the event type is determined, the event metadata may be retrieved from a set of tables identified by event type.

An event validation manager 220 is then used to validate the event data included in the event. For example, using the attribute names and attribute properties defined in the event metadata, event validation manager 220 determines the value corresponding to each attribute name. Event validation manager 220 then checks to see if the values are in the correct format and checks if the data type and data length for the value are consistent with the definition in the event metadata. Additionally, event validation manager 220 checks if the event value is consistent with an enumeration and pattern defined in the event metadata. The enumeration may be the set of named values, elements, members or enumerators for the event type. Also, the pattern may be the specified organization of data. If any inconsistency is found, then an error message may be generated and persisted for output to a user. If the validation succeeds, then event processing may continue.

In one embodiment, the following pseudocode may be used to perform validation:

```
Read table of Event metadata with key event type = incoming event type.
Read table of Event attribute enumeration with key event type =
incoming event type
Loop over event detail data.
  Read table of incoming event metadata with key
            attribute name = incoming attribute name.
  If found.
    If Incoming attribute value is consistent with
      the data type of attribute in event metadata.
      Event passed check.
    Else.
      Raise error.
    End if.
    If Incoming attribute value length is consistent with
      the data length of attribute in event metadata.
      Event Passed check.
    Else.
      Raise error.
    End if.
    Read table of Event attribute enumeration
    with key event type = incoming event type
            Attribute name = event attribute name.
    If Incoming attribute value is consistent with Event attribute
    enumeration.
    Event Passed check.
    Else.
    Raise error.
    End if.
  If Incoming attribute value length is consistent with
    the data length of attribute in event metadata.
      Event Passed check.
  Else.
      Raise error.
  End if.
  If Incoming attribute value is consistent with
    the data pattern of attribute in event metadata.
      Event Passed check.
  Else.
    Raise error.
  End if.
  End if.
End loop.
```

A control rule assignor 222 determines any controls and rules for the event. When the event type is determined, a control that is linked to the event type is determined. For example, when the controls were configured, they were linked to specific event types. Additional data may also be used to determine the control. For example, the event type and a customer ID are used to determine the control. In one configuration, the control that is determined is linked to a process or sub-process associated with an org. unit that is associated with the customer ID and event type. The customer ID may be used to determine the org. unit and process/sub-process. Control rule assignor 222 may look up the control that is linked to the event type in a database table configured for regulatory compliance system 104. Once the control is determined, the control is linked to a rule for processing the events. The rule is associated with the event and stored in an event data storage 224.

Rules engine 214 retrieves the event from event data storage 224 and evaluates the event against the rules linked to the event type. The rules include criteria that are used to test for non-compliance. Based on the criteria defined in a rule, rules engine 214 checks if the event is non-compliant and if there is an issue related to non-compliance.

Rules engine 214 uses the event metadata to evaluate the rule for the control. While building the rules, data attributes there were defined by the event metadata of one event type are retrieved. A user may have configured the rules, for example, the user may define the selection criteria and define the criteria for non-compliance based on the attributes defined in the event metadata. Also, the user may configure the logic or steps used to process the event data using the event metadata knowledge. In the example below, if the event metadata indicates the specific event type contain attributes such as invoice value and customer type, the user may create a rule for checking if the invoice value of a one time customer (a customer type) exceeds $10K, a rule may be built based on the invoice values and item type. At run time, event handling framework 102 interprets event data based on the metadata definition and compare the data to the criteria defined in the rule. For example, a query and retrieve method is used to query a database table for the event type and retrieve the event metadata for the event type. Then, an execution method is used to execute the rule for the event-based control. For example, event data defined by the metadata for the event type is compared to criteria for the rule to determine if the event is non-compliant. If the event is determined to be non-compliant, then it may be handled using various methods that will be discussed below in more detail.

In one example, if an event type includes the metadata for an invoice item value and a customer type, The event metadata is used to determine values for the invoice item and the customer type. The rule may specify that if the value of the invoice item is greater than $10,000 U.S. dollars and the customer type is a one-time customer, then the event is non-compliant. Rules engine 214 determines if the values violate the criteria.

Rules may also be defined for multiple events. For example, an aggregation rule or baseline rule may be defined. The aggregation or baseline rule may be for one specific event type and tests whether the aggregated value of one attribute of multiple events of that event type within a time frame that complies with a specific threshold.

The following pseudo code may be used to evaluate different rules:

```
I) Individual event rule
Example: the invoice amount of one time customer cannot exceed a
threshold defined in the rule.
In the rule it is defined for one specific event type, for one specific
attribute name I_ATTRIBUTE_NAME (invoice amount)
the threshold is I_LIMIT.
Check if incoming event type = I_EVENT_TYPE.
Read table of event detail with key attribute name = ‘Customer type’.
If found.
  Check if attribute value = ‘One time customer’.
  If yes, continue.
  If no, exit.
End if.
Loop over event detail data where attribute name =
I_ATTRIBUTE_NAME.
  Sum = Sum + attribute value.
End of loop.
Check Sum > I_LIMIT.
If yes, non compliance exception found.
If no, continue.
II) Aggregate event rule:
Example: the invoice amount of same customer accumulated in the last
one week cannot exceed a threshold defined in the rule.
Read table of event log
    with key event type = event type of incoming event
          Attribute name = ‘Customer ID’
          Attribute value = customer ID of incoming event.
            Date > date of incoming event - 7.
Loop of table of event log.
  If attribute name = ‘Invoice amount’.
    Sum = Sum + attribute value.
  End if.
End loop.
If Sum > I_THRESHOLD.
  Non compliance exception found.
Else.
  Continue.
End if.
III) Event match rule.
Example: the reference number on the invoice cannot be the same as the
sales order number of one specific vendor.
Read table of event log
    with key event type  = ‘Sales Order’
          Attribute name = ‘Sales Order No’
          Attribute value = reference number of incoming event.
If found.
  Raise an error
Else.
  Continue.
End if.
```

In one example, events may come in at a high rate that may cause performance issues. For example, the evaluation of events and the creation of issues may take processing power and time. Accordingly, a method may be used to adjust the evaluation by rules engine 214.

A batch job may be started that can scan events from event data storage 224 periodically, such as every 5 minutes. This counts the number of events that occurred during that interval. If the number is higher than a certain threshold, then a value for criteria used by rules engine 214 to determine a non-compliance case may be increased. For example, the value may be increased 5% to 10%. If the number of events decreases, then the value may be reduced again to allow more events to be determined to be non-compliant.

Different methods of remediation may be performed when an event is considered non-compliant. For example, when the event is considered to be an issue, the event may be stored in an issue data storage 226. An issue database table may include the following data: an issue ID, status, priority, and event ID. The issue ID identifies the issue, the status is the action status of the issue, the priority is how important the issue is considered, and the event ID is the event identifier.

One method of remediation is to notify a user. Users may be assigned to individual process/control, and organizational units. Issue rules may be used to assign users to perform actions in the event of a non-compliance issue and may be stored in a database table. Based on the result of the analysis, the database table may be accessed based on the rule and users that should take actions for the rule are determined.

Once notified, a user may use a user interface 228 to view the event. The issue information for issue data storage 226 may be displayed to the user through interface 228. For example, user may view the event and determine any workflow tasks and actions that need to be performed to remediate the issues.

Additionally, if a workflow is associated with the issue, then it may be automatically triggered. The workflow may be an automatic process that is designed to perform certain actions. For example, certain users may be notified or actions may be performed automatically. In this case, an issue remediation workflow 230 may be triggered and the workflow performs certain tasks and actions. For example, an outbound interface 232 may be used to send tasks and actions to systems that originated the event or to systems that can remediate the issue. Also, when the workflows are triggered and tasks or actions are forwarded to recipients, a responsible person may handle these issues and try to solve the issues or perform any actions.

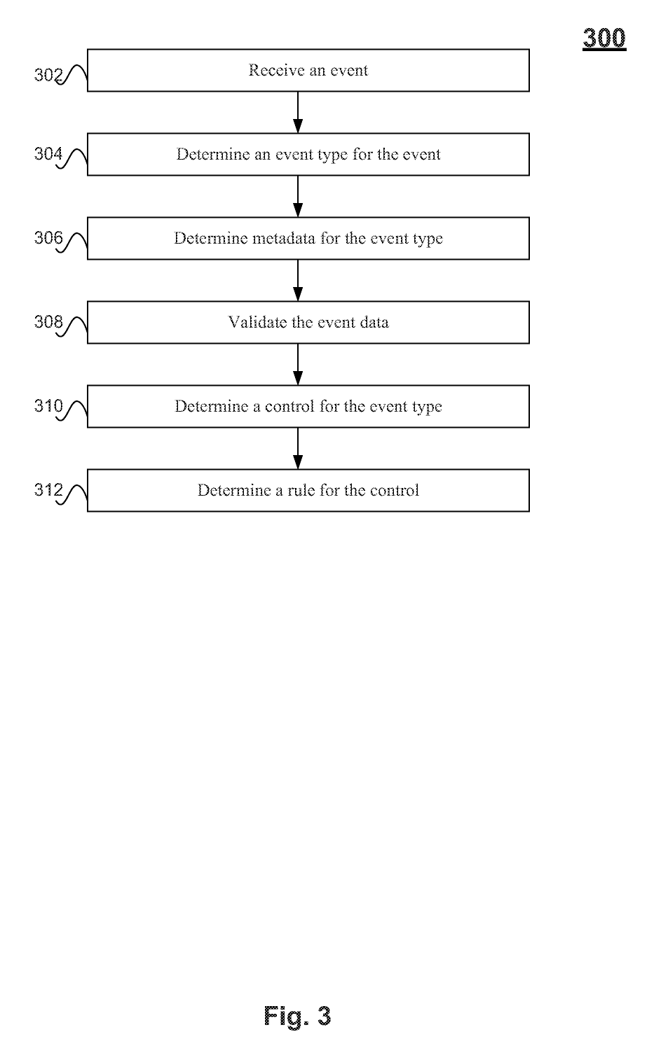

The following method flows for processing events will now be described. FIG. 3 depicts a simplified flowchart 300 of a method for determining a rule for an event according to one embodiment. At 302, an event is received. The event is received through event interface 216.

At 304, event handling service 217 determines an event type for the event. For example, information in the event may define the event type for the event.

At 306, metadata for the event type is determined. The metadata describes the data found in the event.

At 308, event validation manager 220 validates the event data. The validation may determine if the data is in the right format and can be processed by rules engine 214. Also, the validation may filter out invalid data in the event.

At 310, control rule assignor 222 determines a control for the event type. The control may have been linked to the event type during the design of regulatory compliance system 104.

At 312, a rule for the control is determined. The rule may have been linked to the control during the design of rules engine 214.

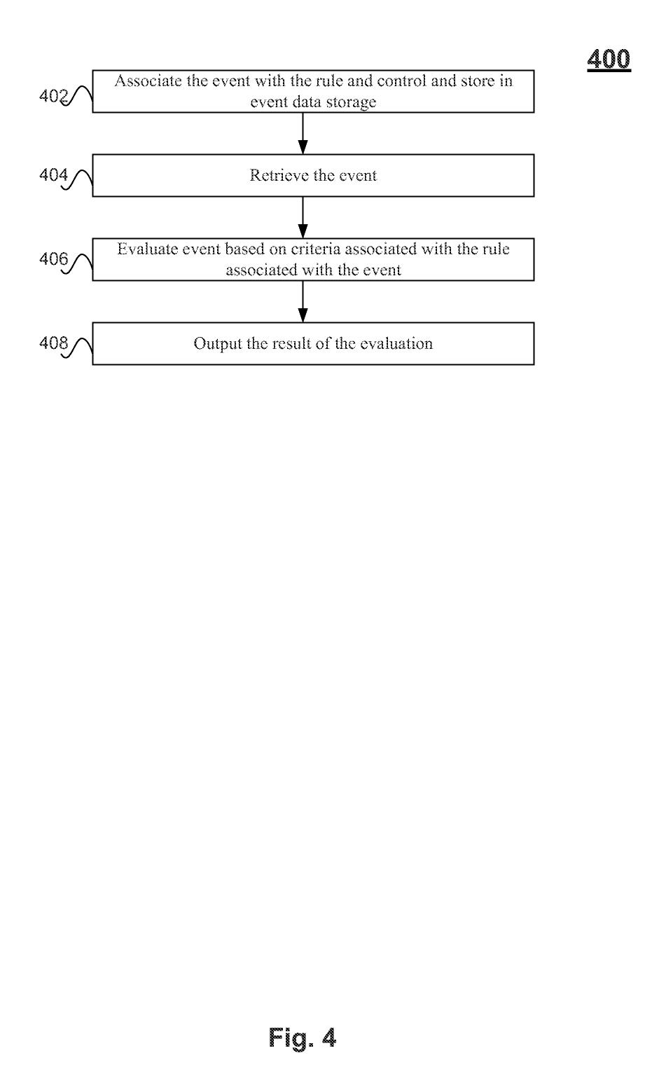

After the rule is determined for the event, then the event may be evaluated. FIG. 4 depicts a simplified flowchart 400 of a method for evaluating an event according to one embodiment. At 402, the event is associated with the rule and control and stored in event data storage 224.

At 404, rules engine 214 retrieves the event. At 406, the event is evaluated based on criteria associated with the rule associated with the event. For example, the metadata is used to determine which data in the event is needed to evaluate the rule. This data is then determined and evaluated against criteria in the rule.

At 408, the result of the evaluation is output. For example, if an issue of non-compliance is determined, then certain remediation actions may be performed.

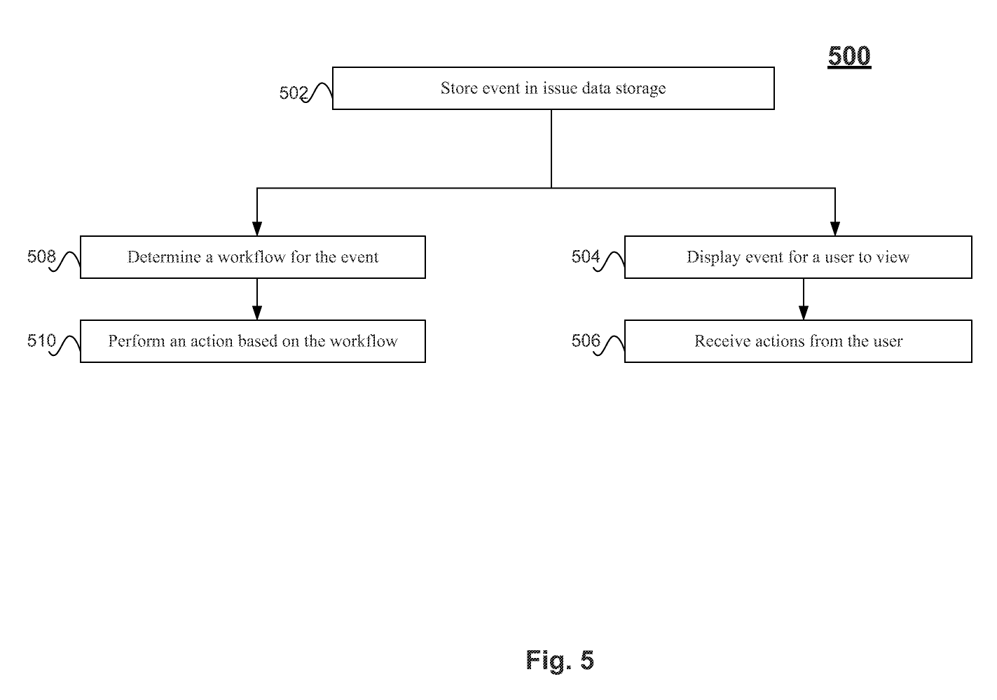

FIG. 5 depicts a simplified flowchart 500 for providing remediation according to one embodiment. At 502, the event is stored in issue data storage 226. Different actions may then be taken. For example, the event may be displayed for a user to view at 504. At 506, actions may be received from the user. For example, the user may analyze the event and determine any actions that need to be performed.

Alternatively, if a workflow exists, at 508 a workflow is determined for the event. For example, different issues are associated with different workflows.

At 510, an action is performed based on the workflow. For example, certain users may be notified with tasks or actions to perform to remediate the issue.

Particular embodiments provide many advantages. For example, regulatory compliance system 104 may be configured in a high level, English language description of company policies. Also, the event handling framework 102 may be configured in a low level language, such as ERP transaction, IT session, and network traffic information. The low level language is a more technical and harder to understand language. The gap may be bridged by defining metadata for different event types that can be used to evaluate events that are received from different systems.

Because the events can be received from different systems, detection is distributed across many systems. The conventional system investigates archived information for signs of policy violations or illegal activities. However, in reality, businesses would like to deal with non-compliant events as they occur. Particular embodiments provide a real-time or near real-time system that maintains policy goals and tracking of issues and remediation in a central area. Compliance is an event-driven approach and particular embodiments are configured to process these events in real-time or near real-time, which limits damage from ongoing business transactions after the non-compliant event occurs. Thus, risk compliance is matched to the actual business reality.

The distributive nature of where various events can occur is a problem for a conventional query-based tool. For example, the query-based tool may not be able to query all different kinds of outside systems. Accordingly, using an event-based system that receives events from distributed systems and can correlate event types to metadata for the event types has many advantages. This also simplifies the compliance because businesses face multiple compliance needs and independently have many policy goals around good management practices. No single person or a single department knows all of these. Thus, a centralized system that can tie all of the policies together provides comprehensive regulatory compliance.

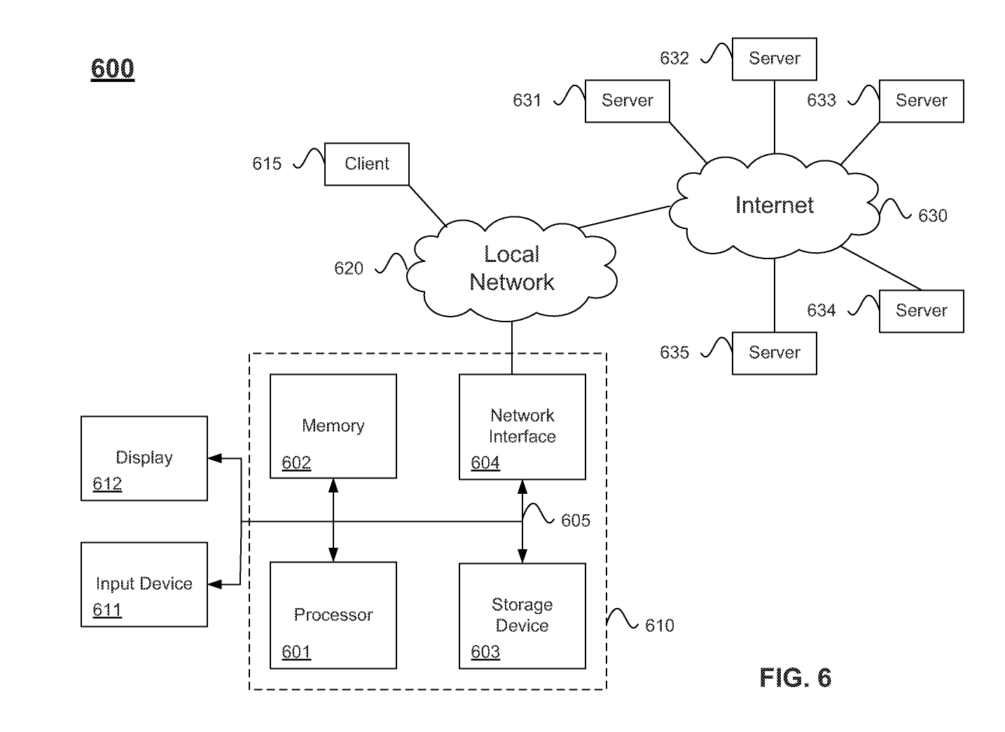

FIG. 6 illustrates hardware of a special purpose computing machine configured with an event-based regulatory compliance system according to one embodiment. An example computer system 610 is illustrated in FIG. 6. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable storage mediums.

Computer system 610 may be coupled via bus 605 to a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 610 can send and receive information through the network interface 604 across a local network 620, an Intranet, or the Internet 630. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above with respect to the event-based regulatory compliance system may be implemented on any computer system and send and/or receive information across a network, for example.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining a plurality of event types, each event type associated with event metadata;
receiving an event;
determining an event type in the plurality of event types for the received event;
determining event metadata for the determined event type;
determining event data from the event based on the event metadata;
determining a rule associated with the event type, the rule including a criterion based on a regulatory compliance issue; and
evaluating, by a computing device, the event data with the criterion to determine if the event is non-compliant or compliant with the regulatory compliance issue.

2. The method of claim 1, wherein determining the rule comprises:
determining a control associated with the event type, the control based on a risk of non-compliance for the regulatory compliance issue; and
determining the rule from the control.

3. The method of claim 2, wherein determining the control comprises:
determining a first link between the event type and the control; and
determining a second link between the control and the rule.

4. The method of claim 3, further comprising receiving a definition of the rule, the definition using event metadata for the event type to define the rule used to test when the event is non-compliant or compliant.

5. The method of claim 4, wherein the definition comprises the criterion for the rule, wherein the event data is evaluated against the criterion to determine if the event is non-compliant or compliant.

6. The method of claim 2, wherein the control and rule are associated with a business process and organization unit.

7. The method of claim 1, further comprising validating the event data from the event to determine if the event data is in a valid format for evaluating.

8. The method of claim 1, further comprising storing the event in event data storage, the stored event awaiting evaluation.

9. The method of claim 8, further comprising:
determining if a number of events stored in the event data storage is above a threshold;
changing a value of a criterion used to evaluate events if the event data storage is above the threshold to cause a percentage of events determined to be non-compliant to decrease; and
changing the value of the criterion used to evaluate the event if the event data storage is below the threshold to cause the percentage of events determined to be non-compliant to increase.

10. The method of claim 1, further comprising outputting remediation information associated with the event if the event is determined to be non-compliant.

11. The method of claim 1, further comprising triggering a workflow to perform predetermined actions for remediating the event if the event is determined to be non-compliant.

12. The method of claim 1, wherein the event is received from an outside system through an event interface.

13. The method of claim 12, further comprising communicating with the outside system to notify the outside system the event was non-compliant with the regulatory issue if the event is determined to be non-compliant.

14. A computer-readable storage medium containing instructions for controlling a computer system to perform a method, the method comprising:
determining a plurality of event types, each event type associated with event metadata;
receiving an event;
determining an event type in the plurality of event types for the received event;
determining event metadata for the determined event type;
determining event data from the event based on the event metadata;
determining a rule associated with the event type, the rule including a criterion based on a regulatory compliance issue; and
evaluating the event data with the criterion to determine if the event is non-compliant or compliant with the regulatory compliance issue.

15. The computer-readable storage medium of claim 14, further comprising:
determining a control associated with the event type, the control based on a risk of non-compliance for the regulatory compliance issue; and
determining the rule from the control.

16. The computer-readable storage medium of claim 15, wherein determining the control comprises:
determining a first link between the event type and the control; and
determining a second link between the control and the rule.

17. The computer-readable storage medium of claim 16, further comprising receiving a definition of the rule, the definition using event metadata for the event type to define the rule used to test when the event is non-compliant or compliant.

18. The computer-readable storage medium of claim 14, further comprising outputting remediation information associated with the event if the event is determined to be non-compliant.

19. The computer-readable storage medium of claim 14, further comprising triggering a workflow to perform predetermined actions for remediating the event if the event is determined to be non-compliant.

20. An apparatus comprising:
one or more computer processors; and
a computer-readable storage medium containing instructions for controlling the one or more computer processors to perform a method, the method comprising:
determining a plurality of event types, each event type associated with event metadata;
receiving an event;
determining an event type in the plurality of event types for the received event;
determining event metadata for the determined event type;
determining event data from the event based on the event metadata;
determining a rule associated with the event type, the rule including a criterion based on a regulatory compliance issue; and
evaluating the event data with the criterion to determine if the event is non-compliant or compliant with the regulatory compliance issue.
